(19) United States
(12) Patent Application Publication
(10) Pub. No.: US 2020/0288052 A1
(43) Pub. Date: Sep. 10, 2020

(54) IMAGE CAPTURING DEVICE FOR AUTO EXPOSURE

(71) Applicant: Himax Imaging Limited, Tainan City (TW)

(72) Inventors: Amit MITTRA, Tainan City (TW); Tony CHIANG, Tainan City (TW); Felix SU, Tainan City (TW)

(21) Appl. No.: 16/296,247

(22) Filed: Mar. 8, 2019

(51) Int. Cl. H04N 5/235; H04N 5/3745

(52) U.S. Cl. CPC H04N 5/2353; H04N 5/3745; H04N 5/2351

(57) ABSTRACT

An image capturing device including an image sensing circuit and a processing circuit is provided. The processing circuit controls the image sensing circuit to sense at least one partial frame before sensing a full frame. A number of pixels of the partial frame is less than a number of pixels of the full frame, and exposure time of the partial frame is shorter than exposure time of the full frame. The processing circuit performs an automatic exposure procedure according to the partial frame to calculate a fast exposure time and gain, transforms the fast exposure time and gain into exposure time and gain for the full fame, and control the image sensing circuit to sense the full frame accordingly.

### BACKGROUND

### Field of Invention

The present invention relates to an image capturing device. More particularly, the present invention relates to the image capturing device for rapidly adjusting an exposure parameter.

### Description of Related Art

Automatic exposure, automatic focusing, automatic white balance are important functions in a digital camera system. The automatic exposure is configured to adjust aperture, shutter speed, etc. while a gain is typically controlled correspondingly according to the brightness of the scene to generate desired signal levels of an image. In some conventional automatic exposure algorithms, an image or series of images are captured with a preset aperture and a preset shutter speed. Next, scene statistics such as, but not limited to, histogram of signal levels, average brightness, a median brightness, and/or a maximum brightness of the image, or regions of interest within the image(s), are calculated, and then the aperture and the shutter speed are adjusted accordingly. However, the conventional automatic exposure algorithm may require a large amount of time for reading out the signal levels, for the computation, based on factors such as size of the frame, numbers of the frames to be read out and processor design, and additional considerations for control loop stability design and overlapping exposure and read time of a rolling shutter. In applications where the camera system captures sporadic or periodic images with prolonged blanking time, the period between two image frames or image frame sets may be long while no data is being captured. In this case, changes in scene during the blanking period will not be considered by the automatic exposure algorithm, leading to automatic exposure algorithm error which causes control loop instability and/or longer time for the automatic algorithm to converge. Therefore, it is an issue to those skilled in the art about how to propose a faster automatic exposure algorithm.

### SUMMARY

Embodiments of the present disclosure provide an image capturing device including an image sensing circuit and a processing circuit. The processing circuit is electrically connected to the image sensing circuit and is configured to control the image sensing circuit to sense at least one partial frame before sensing a full frame. A number of pixels of the partial frame is less than a number of pixels of the full frame, and exposure time of the partial frame is shorter than exposure time of the full frame. The processing circuit performs an automatic exposure procedure according to the partial frame to calculate at least one fast exposure parameter, transforms one of the fast exposure parameter into a full frame exposure parameter, and control the image sensing circuit to sense the full frame according to the full frame exposure parameter.

In some embodiments, the image capturing device further includes an amplifier and an analog to digital converter. The amplifier is disposed between the image sensing circuit and the processing circuit for amplifying signals from the image sensing circuit and outputting amplified signals. The analog to digital converter is configured to receive the amplified signals and output digital signals to the processing circuit. The processing circuit sets a gain of the amplifier such that a gain corresponding to the partial frame is greater than a gain corresponding to the full frame. In some embodiments, the gain can also be applied digitally at any point after the process of the analog to digital converter.

In some embodiments, the processing circuit controls the image sensing circuit to read only pixels corresponding to a region of interest to generate the partial frame.

In some embodiments, the processing circuit controls the image sensing circuit to perform a pixel binning procedure to pixels to generate the partial frame.

In some embodiments, the processing circuit controls the image sensing circuit to perform down sampling to pixels to generate the partial frame.

In some embodiments, a number of the partial frame is greater than one, and the partial frames include a first partial frame and a second partial frame which is sensed after the first partial frame. At least one fast exposure parameter includes a first fast exposure parameter and a second fast exposure parameter. The processing circuit calculates the first fast exposure parameter according to the first partial frame, controls the image sensing circuit to sense the second partial frame according to the first fast exposure parameter, calculates the second fast exposure parameter according to the second partial frame, and transforms the second fast exposure parameter into the exposure parameter.

In some embodiments, the image capturing device is in a sleeping mode or a shutdown mode before the partial frame is sensed.

In some embodiments, before the image sensing circuit senses the partial frame, the processing circuit controls the image sensing circuit to sense a previous full frame, and performs the automatic exposure procedure according to the previous full frame to calculate a previous exposure parameter, and transforms the previous exposure parameter into a previous fast exposure parameter, and controls the image sensing circuit to sense the partial frame according to the previous fast exposure parameter.

### BRIEF DESCRIPTION OF THE DRAWINGS

The invention can be more fully understood by reading the following detailed description of the embodiment, with reference made to the accompanying drawings as follows.

FIG. 1 is a schematic block diagram of an image capturing device in accordance with an embodiment.

FIG. 2 is a schematic diagram of a process for determining exposure parameters in accordance with an embodiment.

FIG. 3A, FIG. 3B, and FIG. 4A to FIG. 4C are schematic diagrams of a full frame and a partial frame in accordance with some embodiments.

FIG. 5 to FIG. 8 are schematic diagrams of processes for capturing multiple full frames by the image capturing device in accordance with some embodiments.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology, but are not referred to particular order or sequence.

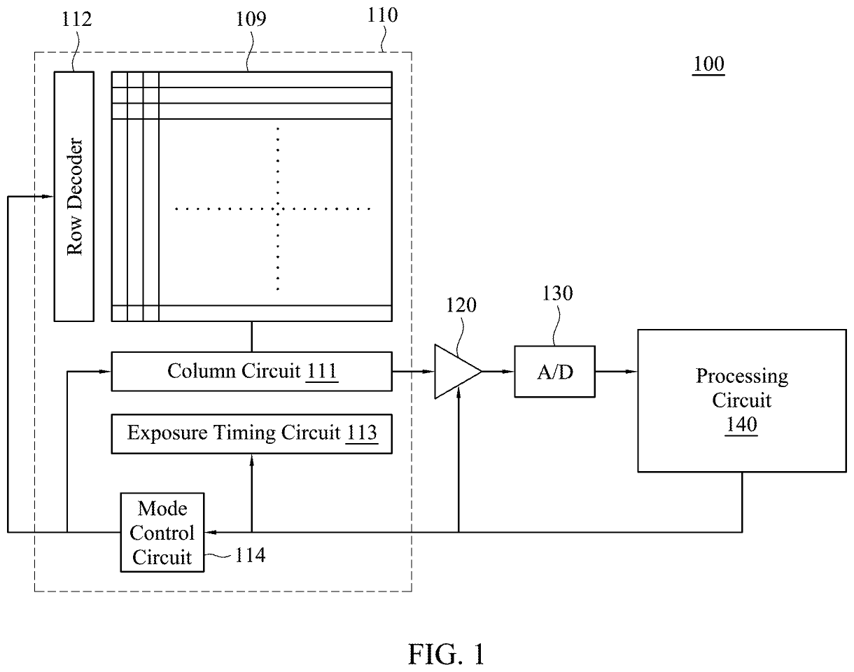

FIG. 1 is a schematic block diagram of an image capturing device in accordance with an embodiment. Referring to FIG. 1, an image capturing device 100 includes an image sensing circuit 110, an amplifier 120, an analog to digital converter 130, and a processing circuit 140. The amplifier 120 is disposed between the image sensing circuit 110 and the processing circuit 140. The analog to digital converter 130 is disposed between the amplifier 120 and the processing circuit 140. The image sensing circuit 110 includes optical sensing units 109, a column circuit 111, a row decoder 112, an exposure timing circuit 113, and a mode control circuit 114. The optical sensing units 109 are, for example, charge-coupled device (CCD) sensors, complementary metal-oxide semiconductor (CMOS) sensors, or other suitable optical sensors. In some embodiments, the optical sensing units 109 are arranged as columns and rows where each optical sensing unit 109 is configured to sense a pixel. The column circuit 111 and the row decoder 112 enables particular column(s) and row(s) respectively to read the respective pixel(s). The exposure timing circuit 113 is configured to control exposure time. The mode control circuit 114 determines which column(s) and row(s) are enabled according to a signal received from the processing circuit 140. The pixels (in the form of analog voltage signals) read by image sensing circuit 110 are transmitted to the amplifier 120 to output amplified signals to the analog to digital converter 130. The analog to digital converter 130 receives the amplified signals and outputs digital signals (representing brightness of the pixels) to the processing circuit 140. The processing circuit 140 is configured to control a gain of the amplifier 120, the exposure time, and determine whether a full frame or a partial frame is read.

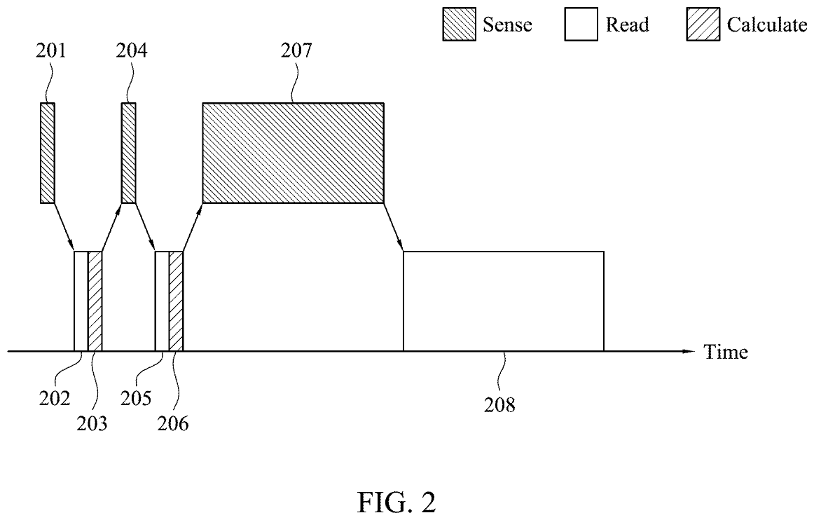

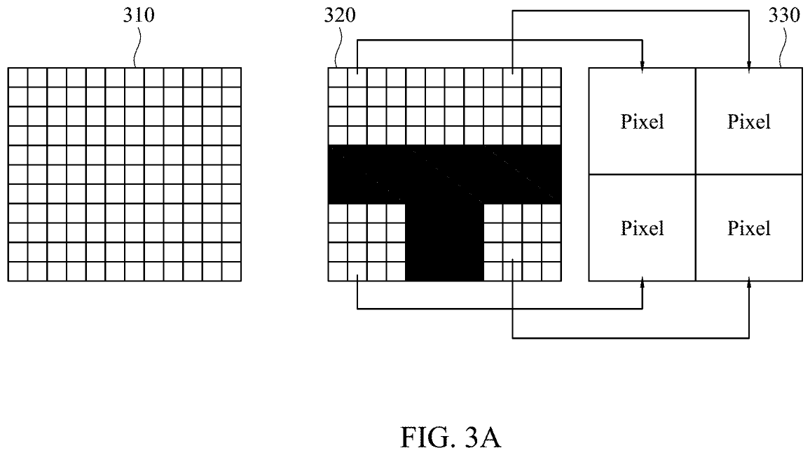

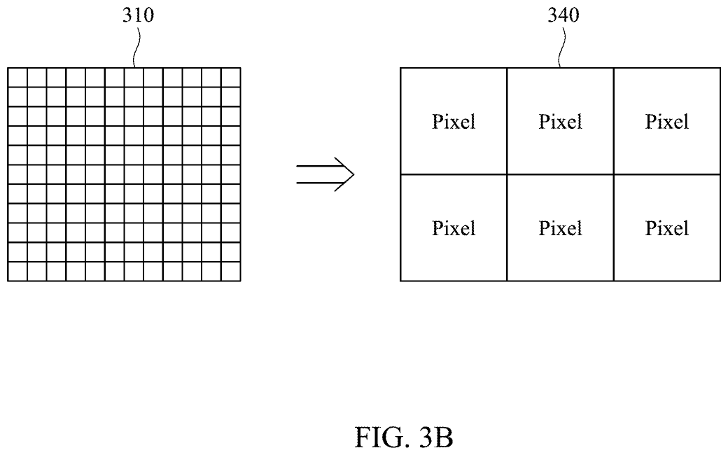

In detail, referring to FIG. 1 and FIG. 2 which is a schematic diagram of a process for determining exposure parameters in accordance with an embodiment. For the first instance, the processing circuit 140 obtains a predetermined exposure time for the optical sensing units 109 in period 201 and a predetermined gain for the amplifier 120 in period 202. In a period 201, the optical sensing units 109 sense a frame according to the predetermined exposure time. In a period 202, the processing circuit 140 transmits a signal to the mode control circuit 114 for enabling a portion of the columns and rows to read a partial fame in which the number of pixels of the partial frame is less than the number of pixels of the full frame. The predetermined gain is applied to the amplifier 120 for reading the partial fame. Note that the predetermined gain is greater than a preset gain for a full frame. For example, the predetermined gain of the amplifier 120 is N times of the preset gain where N is a real number greater than 1. For example, referring to FIG. 3A which is a schematic diagram of the full frame and the partial frame in accordance with some embodiments. A full frame 310 is the frame formed after all pixels of the optical sensing units 109 are read. A partial frame 320 is the frame formed after only a portion of the pixels of the optical sensing units 109 are read. In the embodiments of FIG. 3A, all the pixels of the optical sensing units 109 are divided into several regions, and the partial frame 320 only includes the pixels in the regions of interest (ROI) at four corners. In some embodiments, a pixel binning procedure is performed to the pixels in each region of the partial frame 320 to output a signal level (representing brightness), and all the signal levels constitute a partial frame 330. As a result, the partial frame 330 includes only four signal levels (i.e. including four pixels). The circuit (not shown) for performing the pixel binning procedure is disposed in the image sensing circuit 110, but person skilled in the art should be able to understand the pixel binning procedure, and therefore it will not be described herein. Note that the partial frames 320 and 330 have fewer pixels than the full frame, and therefore the period 202 for reading the partial frame is relatively shorter. In some embodiments, the processing circuit 140 controls the image sensing circuit 110 to perform down-sampling to the pixels of the optical sensing units 109 to generate a partial frame. For example, in the embodiment of FIG. 3B, the pixel binning procedure or the down-sampling is performed to the full frame 310 to obtain a partial frame 340 which includes only six signal levels.

The location, size, and shape of ROI may be determined arbitrarily. For example, in the embodiment of FIG. 4A, a full frame 410 has a ROI 420, and only the pixels in the six regions 431-436 are read to output the partial frame. In an embodiment, the pixel binning procedure is further performed to the pixels in the regions 431-436 to obtain six signal levels that are outputted as the partial frame. In some embodiments, the pixel binning procedure is used to average the pixels. In other embodiments, each pixel may be multiplied by a weight and then summed up where the weights may be different from each other, which is not limited in the invention. Furthermore, the three approaches of down-sampling, ROI, and the pixel binning procedure can be combined arbitrarily. For example, in the embodiment of FIG. 4B, there is only one ROI 440 in the full frame 310. The pixel binning procedure or the down-sampling is performed to the pixels in the ROI 440 to obtain the partial frame 450. In the embodiment of FIG. 4C, there are two ROI 461 and 462 in the full frame 310, and the pixel binning procedure or the down-sampling is performed to the pixels in the ROI 461 and 462 to obtain the partial frame 470. Any other approach which can generate a partial frame having fewer pixels than the full frame is in the scope of the present disclosure.

Referring to FIG. 2, in a period 203, the processing circuit 140 performs an automatic exposure procedure according to the read partial frame to calculate a set of fast exposure parameters which includes, for example, calculated exposure time and calculated gain. For instance, the average of all signal levels of the partial frame is calculated, and whether the average is close to a predetermined value is determined. If the average is less than the predetermined value, the exposure time is increased; if the average is greater than the predetermined value, the exposure time is decreased; if the difference between the average and the predetermined value is in a predetermined range, the adjustment of the exposure time stops. In some embodiments, the set of fast exposure parameters may further include a size of an aperture if the image capturing device includes the aperture. The gain is calculated based on the calculated exposure time. The aforementioned automatic exposure procedure is just an example, and the content of the automatic exposure procedure is not limited in the invention.

In the embodiment of FIG. 2, the difference between the predetermined value and the average of all signal levels of the partial frame is not in the predetermined range. Therefore, in a period 204, the processing circuit 140 controls the image sensing circuit 110 to sense a second partial frame according to a calculated exposure time of the set of calculated fast exposure parameters. In a period 205, the processing circuit 140 controls the image sensing circuit 110, the amplifier 120 and the analog to digital converter 130 to read a second partial frame according to a calculated gain of the set of calculated fast exposure parameters. In a period 206, the processing circuit 140 performs the automatic exposure procedure according to the second partial frame read in period 205 to calculate a second set of fast exposure parameters (also referred to a second fast exposure parameter). In the embodiment, the second set of fast exposure parameters does not need further adjustment (e.g., the difference between the predetermined value and the average of all signal levels of the second partial frame is in the predetermined range), and thus the processing circuit 140 transforms the second set of fast exposure parameters into an set of exposure parameters for a full frame.

Next, in a period 207, the processing circuit 140 controls the image sensing circuit 110 to sense the full frame according to the transformed second set of fast exposure parameters. Note that the period 207 is longer than the periods 201 and 204 because the gain of the amplifier 120 adopted in the period 207 is smaller than that of the period 201 and 204, and thus longer exposure time is needed. In a period 208, the processing circuit 140 controls the image sensing circuit 110 to read the full frame. The period 208 is longer than the periods 202 and 205 because the number of the pixels to be read in the period 208 is greater than that of the periods 202 and 205. In summary, the set of exposure parameters for the full frame is determined rapidly by sensing one or more partial frame before sensing the full frame. The set of exposure parameters for the full frame is obtained rapidly based on sensing a total of two partial frames before sensing the full frame in the embodiment of FIG. 2, but the invention is not limited thereto. In other embodiments, more or less partial frame may be sensed before sensing the full frame.

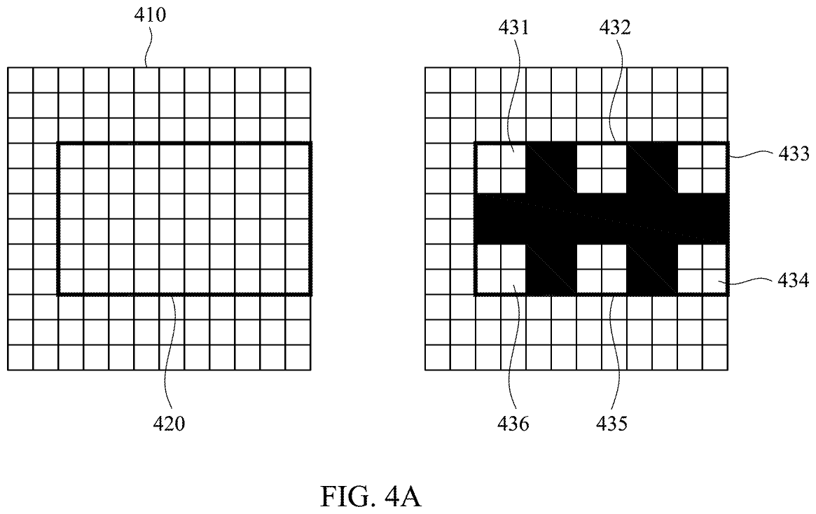

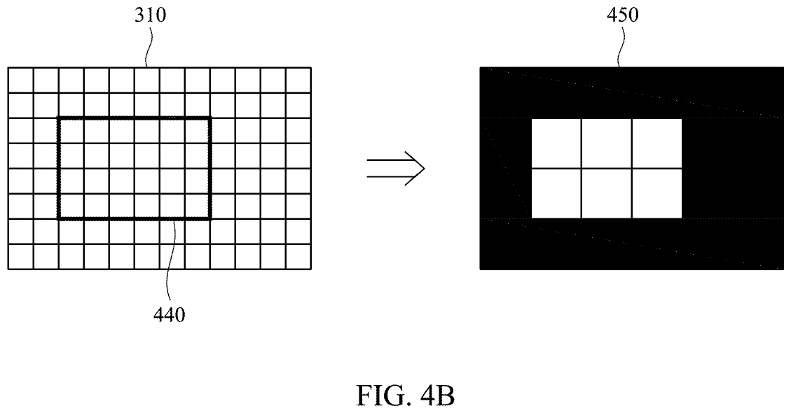

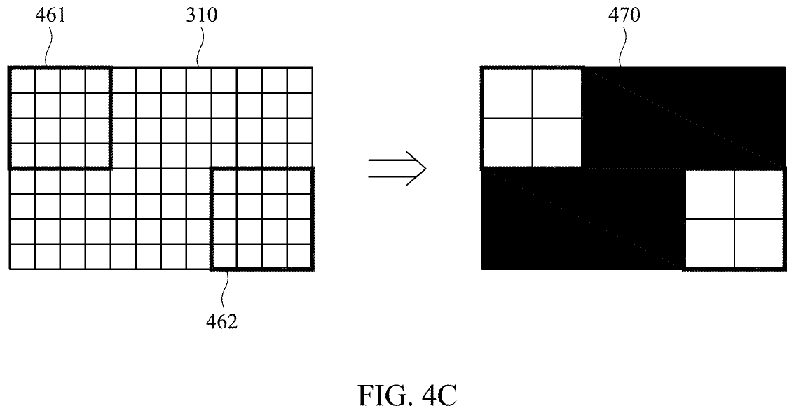

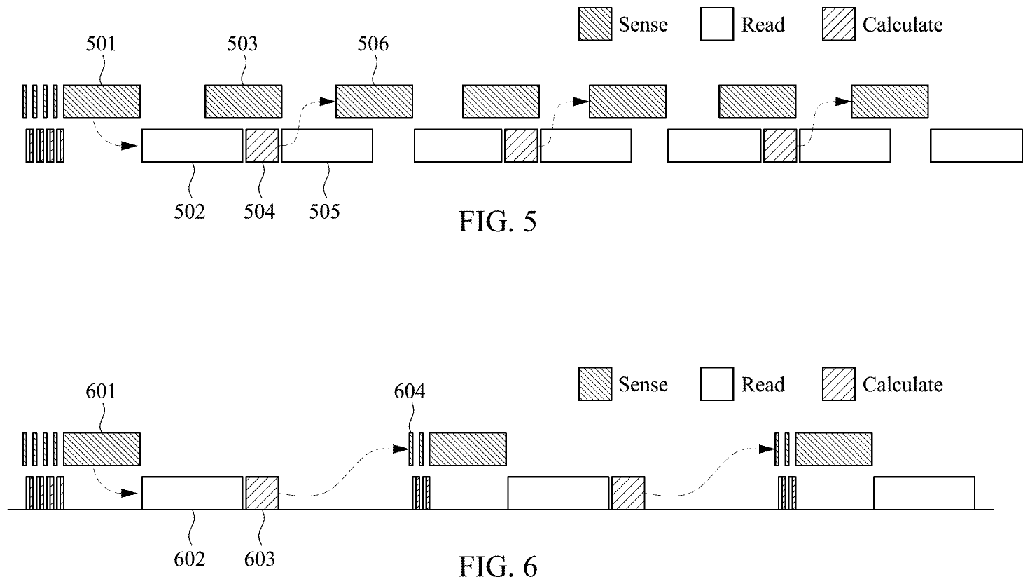

FIG. 5 to FIG. 8 are schematic diagrams of processes for capturing multiple full frames by the image capturing device in accordance with some embodiments. Referring to FIG. 5, a total of four partial frames are sensed before the period 501. The mechanism of sensing the partial frames has been described in detail above, and therefore the description will not be repeated. A set of fast exposure parameters calculated according to the last partial frame is transformed into a set of exposure parameters for the full frame that is applied to the period 501 to sense a full frame. A first full frame is read in a period 502, and the first full frame is used to calculate a set of new exposure parameters in a period 504. In addition, a second full frame is sensed in a period 503 by adopting the set of exposure parameters same as that adopted in the period 501. A second full frame is read in a period 505. The set of exposure parameters calculated in the period 504 is used in a period 506 to sense a third full frame, and so on. Therefore, multiple partial frames are sensed only before the first full frame, and a conventional automatic exposure procedure may be adopted when sensing other full frames.

In the embodiment of FIG. 6, a sample frequency of the full frames is relatively larger, and that is, a time gap between two full frames is relatively longer. In this case, one or more partial frame may be sensed before sensing every full frame. To be specific, the first full frame is sensed in a period 601. The first full frame is read in a period 602 and used to calculate a set of new exposure parameters in a period 603. The set of calculated exposure parameters is transformed and used in a period 604 to sense a partial frame. For example, the gain calculated in the period 603 is multiplied by N times, and the exposure time calculated in the period 603 is divided by N. From another aspect, before sensing the partial frame in the period 604, the processing circuit 140 controls the image sensing circuit 110 to sense and read a previous full frame in the periods 601 and 602. The automatic exposure procedure is performed according to the previous full frame to calculate a set of previous exposure parameters which is transformed into a set of previous fast exposure parameters in the period 603. At last, the image sensing circuit 110 is controlled to sense a partial frame according to the set of previous fast exposure parameters in the period 604.

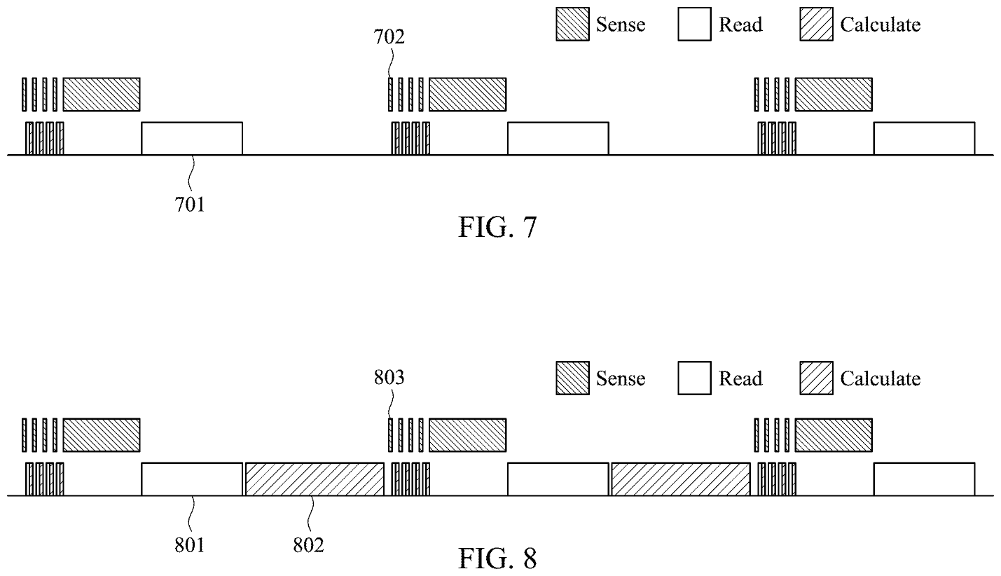

Referring to FIG. 7, the difference between FIG. 6 and FIG. 7 is that after the first full frame is read in a period 701, the first full frame will not be used to calculate a set of new exposure parameters. In a period 702, a set of preset exposure parameters (exposure time and gain) is used to sense and read a partial frame, and then the set of exposure parameters for the full frame is calculated according to the procedure which has been described in FIG. 2.

Referring to FIG. 8, in some embodiments, after the first full frame is read in the period 801, the image capturing device enters a sleeping mode or a shutdown mode in a period 802 to reduce the power consumption. Then, the image capturing device is woke up in a period 803 to sense a partial frame.

In the provided image capturing device, the mechanism of the partial frame can reduce the exposure time and reading time, and thus the exposure parameter for the full frame can be calculated rapidly.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. An image capturing device, comprising:
an image sensing circuit; and
a processing circuit electrically connected to the image sensing circuit and configured to control the image sensing circuit to sense a first partial frame before sensing a full frame, wherein a number of pixels of the first partial frame is less than a number of pixels of the full frame, and exposure time of the first partial frame is shorter than exposure time of the full frame,
wherein the processing circuit performs an automatic exposure procedure according to the first partial frame to calculate a first fast exposure parameter,
wherein the processing circuit determines if a difference between an average of a plurality of signal levels of the first partial frame and a predetermined value is in a predetermined range,
wherein if the difference between the average of the signal levels of the first partial frame and the predetermined value is in the predetermined range, the processing circuit transforms the first fast exposure parameter into an exposure parameter comprising the exposure time of the full frame,
wherein if the difference between the average of the signal levels of the first partial frame and the predetermined value is not in the predetermined range, the processing circuit controls the image sensing circuit to sense at least one second partial frame according to the first fast exposure parameter, calculates at least one second fast exposure parameter according to the at least one second partial frame until a difference between an average of signal levels of the at least one second partial frame and the predetermined value is in the predetermined range, and transforms the at least one second fast exposure parameter into the exposure parameter,
wherein the processing circuit controls the image sensing circuit to sense the full frame according to the exposure parameter.

2. The image capturing device according to claim 1, further comprising:
an amplifier disposed between the image sensing circuit and the processing circuit for amplifying signals from the image sensing circuit and outputting amplified signals; and
an analog to digital converter configured to receive the amplified signals and output digital signals to the processing circuit,
wherein the processing circuit sets a gain of the amplifier such that a gain corresponding to the first partial frame and the at least one second partial frame is N times of a gain corresponding to the full frame, where is a real number greater than 1,
wherein the processing circuit multiplies exposure time of the at least one second partial frame by N to obtain the exposure time of the full frame.

3. The image capturing device according to claim 1, wherein the processing circuit controls the image sensing circuit to read only pixels corresponding to a region of interest to generate the first and the at least one second partial frames.

4. The image capturing device according to claim 1, wherein the processing circuit controls the image sensing circuit to perform a pixel binning procedure to pixels to generate the first and the at least one second partial frames.

5. The image capturing device according to claim 1, wherein the processing circuit controls the image sensing circuit to perform down sampling to pixels to generate the first and the at least one second partial frames.

6. (canceled)

7. The image capturing device according to claim 1, wherein the image capturing device is in a sleeping mode or a shutdown mode before the first partial frame is sensed.

8. The image capturing device according to claim 1, wherein before the image sensing circuit senses the first partial frame, the processing circuit controls the image sensing circuit to sense a previous full frame, and performs the automatic exposure procedure according to the previous full frame to calculate a previous exposure parameter, and transforms the previous exposure parameter into a previous fast exposure parameter, and controls the image sensing circuit to sense the first partial frame according to the previous fast exposure parameter.
